(19) United States
(12) Patent Application Publication
(10) Pub. No.: US 2007/0219971 A1
(43) Pub. Date: Sep. 20, 2007

(54) Apparatus and method for production and representation of relations in a database

(75) Inventors: Oliver Biermann, Koln (DE); Frank-Nils Penkert, Monheim (DE)

Correspondence Address: NORRIS, MCLAUGHLIN & MARCUS, 875 THIRD AVE, 18TH FLOOR, NEW YORK, NY, 10022, US

(73) Assignee: BAYER BUSINESS SERVICES GmBH, Leverkusen (DE)

(21) Appl. No.: 11/724,400

(22) Filed: Mar. 15, 2007

(30) Foreign Application Priority Data
Mar. 16, 2006 (DE) 10 2006 012 039.6
Nov. 3, 2006 (DE) 10 2006 051 772.5

(51) Int. Cl. G06F 17/30

(52) U.S. Cl. 707/3

(57) ABSTRACT

The present invention relates to a method and an associated apparatus for searching and representation of contents of data sources, in particular of contents of relational databases, and to a data storage medium on which the method according to the invention is stored.

### BACKGROUND OF THE INVENTION

The present invention relates to a method and an associated apparatus for searching and representation of contents of data sources, in particular of contents of relation databases, whose efficiency can be improved by means of an improved interface between the user and the database, for example a production process and the marketing of products, by speeding up the procedures.

In general, the term “relation” refers to a relationship between attributes for a key, which is reproduced by a table. In the simplest sense, a relational database is a database which manages data in the form of tables. For the purposes of the invention, the term “relation” in fact refers to a relationship or a link between tables (=types, entities).

In known databases, query and data care are carried out by means of so-called database management programs (DBMS). These are systems which on the one hand carry out the access processes which are required by applications, such as reading, editing, insertion and deletion of data in the database, resulting in the operations which are required to carry out the access requests being carried out at the physical level, and ensuring that the data is output to the user in the form defined in the external schema and providing the between subsequent layers or abstraction levels. SQL provides a widely used and largely standardized query language for relational databases.

In known databases, database management programs admittedly ensure that the data storage, query and representation are subdivided and are distributed between entities. However, the actual relations between entities/types of distributed information are not visible to the user and cannot be traced, or can be traced only with difficulty, by the user. The known applications and database management programs are restricted to presentation of the data in masks or tabular lists (on the basis of association criteria). In the case of the prior art, a query is carried out, for example, using hierarchical tree structures. In this case, objects and information are organized by means of the levels in a tree structure, for example, with one classification feature being asked via each level. The tree structure is either predetermined in a fixed manner by an application or can be defined by the user before he searches for the information. The information is likewise presented hierarchically in the prior art, since the classification features are firmly linked with individual levels in the tree structure. In order to allow a relation between the data records to be asked and/or identified, the user or the query has to follow the tree structure on the basis of the association criteria. According to the prior art, every possible question is dealt with by means of a dedicated tree. If there are n possible features, n! different tree structures must be asked. Because of this, a query of the database for relations or relationships is complicated, time-consuming and generally does not lead to the desired result.

Furthermore, there is no provision of the query results to make the relations between the data records evident. In consequence, not only are existing relations disadvantageously generally concealed from the user, but, even if they are known to the user before a query, they can be asked only with a comparatively large amount of effort in the database.

### BRIEF SUMMARY OF THE INVENTION

Against the background of the disadvantages described above, the object of the present invention is therefore to provide an interface between the user and the database for searching of a data source, which allows improved and more efficient information query and representation on the basis of relations between data records or objects, in order in this way to speed up production and marketing procedures.

This object is achieved by the apparatus according to the invention. Advantageous refinements are specified in the dependent claims. A computer program which achieves the object and a data storage medium containing the computer program according to the invention are likewise the subject matter of the present invention.

The method according to the invention for searching of a database provides that at least one data record is searched and retrieved from the database, and that at least one relation, which is linked to the data record, with at least one further data record is retrieved.

The apparatus according to the invention includes a database, a data input appliance and a data output appliance, which are designed such that, when at least one first data record is searched from the database, at least one relationship which is associated with that data record is retrieved with at least one further data record.

In one particular embodiment of the apparatus, data records and relations are produced by a data preprocessing appliance.

In one particular embodiment of the apparatus according to the invention, the data preprocessing appliance comprises a query module, a data record display module which dynamically produces and displays a data record, and a relation display module, which dynamically retrieves and displays the relations between the data record that is produced and further data records, preferably in a star-shaped representation.

The relation according to the invention in general provides an association between all forms of relationships and dependencies of objects and data, in particular for the linking of tables (=types, entities) to one another.

Query systems which are linked to databases are in general subdivided into three layers, (1) physical data memory (2) middle tier/access layer and a (3) user interface. In this case, the middle tier/access layer comprises the processing which is carried out between the database and the user interface. For example, the middle tier/access layer is carried out on an application server, thus providing the accesses from a so-called client computer to a database which is located on a database server.

In one particular embodiment of the apparatus according to the invention, the data preprocessing appliance includes the access layer of a query system.

The present invention can be used with all types of physical data storage systems and is also essentially independent of the access layer.

The retrieval of the data record together with the associated relation or relations, for example by means of a common display on a data output appliance, allows the linking of the data records with other further data records to be displayed to the user, and to be evaluated, particularly quickly. Separate query of the database according to the prior art, for example on the basis of predetermined tree structures in order to create the relation between the data records that have been found on the basis of the results that have been found is comparatively time-consuming and complicated.

As already mentioned, provision according to the invention comprises outputting on an output appliance, such as a screen or printer.

The data sources according to the invention may comprise any database systems, such as trip databases, Lotus Notes/Domino databases or else simple file systems. According to the invention, the check may cover a plurality of data sources, that is to say databases or servers in a search system.

For the purposes of the invention, data sources are preferably relational databases with associated management systems, or object-oriented relational databases with associated management systems. Examples of database management systems such as these include Oracle®, PostgreSQL, Microsoft SQLServer® or DB/2, Sybase Adaptive Server Enterprise, Sybase Adaptive Server Anywhere, Sybase IQ, MySQL, Firebird, Apache XINDICE, Tamino®, Teradata®, Cloudscape, Berkeley DB, Berkeley DB XML, HSQL or MaxDB®, preferably Oracle®, PostgreSQL or Microsoft SQLServere.

The search or query is normally carried out in relational databases using the SQL query language (Structured Query Language). This has a predetermined syntax and provides a range of commands for definition of data structures based on relational algebra for manipulation of databases (joining, processing and deletion of data records) in order to search data. The data records retrieved in this way, and information relating to relations of data records, are referenced by means of keys or identifiers. In the present invention, this information is used to represent the relation as being associated with the data structure, and can thus be taken into account further during a query, that is to say it is navigable.

In one particular embodiment of the apparatus according to the invention, the display of data records and relations can be controlled by a rights allocation module. In particular, selective display of data is required when the database is intended to access data that is subject to personal data protection.

A search or query is normally responded to in the case of the present invention by an investigation of a reference object and its relations with further data records, in which case both direct relations and indirect relations can be investigated by navigation through the circuitous route of further reference objects (see for example FIG. 1). The lack of relations can likewise be investigated using the present invention.

For the purposes of the present invention, a reference object is a data record or a selection of a plurality of data records.

One special embodiment of the method according to the invention has the following steps:
a) input and search of one or more reference objects
b) retrieval of one or more reference objects
c) retrieval of the relations between the reference objects with further data records
d) output of the reference objects and relations between the reference objects with further data records to the output appliance.

The search for relations between the data records may be particularly complex when their presence can only be supposed and, for this purpose, each data record must be checked individually. Retrieval of the data records with an associated relation can therefore not only improve the validity of the data produced, but can also speed up the evaluation of the data records in the database.

The retrieval of the data record together with the associated relation or relations, for example by means of a common display on a data output appliance, allows the linking of the data records with other further data records to be displayed to the user, and to be evaluated, particularly quickly. Separate query of the database according to the prior art, for example on the basis of predetermined tree structures in order to create the relation between the data records that have been found on the basis of the results that have been found is comparatively time-consuming and complicated.

In a further advantageous refinement of the method according to the invention, at least one further associated data record is retrieved in addition to the relation, and is linked to the first data record via the abovementioned relation. Only one selection of the further data record is preferably displayed dynamically, with this being related to the reference object.

In one preferred embodiment of the invention, in the retrieval of the further data record, the relations linked to this are in turn displayed, that is to say the relations linked to data records are adapted dynamically.

According to a further advantageous refinement of the method according to the invention, in a further step of the method, at least one further data record is retrieved after confirmation in a confirmation step. For example, the further data record is retrieved by operation of a key, by clicking of an input appliance or by touching a touch-sensitive display in a confirmation field that is provided for this purpose. This allows the production of information on the data output appliance to be speeded up, since the amount of data to be produced and to be output is increased only “on request”, that is to say on confirmation. Furthermore, production on a confirmation-controlled basis improves the clarity.

In a further advantageous refinement of the method according to the invention, the production of the first data record is interrupted after confirmation in the confirmation step. In consequence, the amount of data to be produced does not increase after confirmation, since the presentation of the data record takes place sequentially. Furthermore, the clarity is improved by sequential production.

In a further advantageous refinement, the data records that are produced are selected, and at least one relation linked to the selection is retrieved. This results in the data record being reduced in size by the selection process, for example by means of selective choice (tick marks) or via an attribute search, with a relation linked to the selection once again being displayed.

One particular embodiment of the method according to the invention therefore has the following steps:
a) input and search of one or more reference objects
b) retrieved of one or more reference objects
c) retrieved of the relations between the reference objects with further data records
d) output of the reference objects and relations between the reference objects with further data records to the output appliance.
e) selection of a relation by operation of a confirmation key,
f) retrieved of the further data record or selection of the data record in relation with the reference object,
g) retrieved of the relations of the further data record or selection of the data record with further data records,
h) output of the further data record or selection of the data record and its relations to the output appliance.

The user can navigate along the relations between data records within the database by repetition of steps e) to h). During this process, the relation to the reference object is preferably retrieved and indicated, preferably to identify, in the output of a further data record as well.

In one advantageous refinement, the output of or display of the further data records is produced in a star shape around the data record that is produced as the first data record, with the star-shaped linking reflecting the relation between the data records. By way of example, index cards and tabs can be used to represent data records and relations, in which case the tab can be used as a confirmation field. Any other type of confirmation field is likewise possible, such as normal hyperlinks, buttons, text, or lists. The star-shaped output and display are preferably presented three-dimensionally. Index cards and tabs or a 3-D star or sphere (see for example Figure X) may be mentioned as examples of 3-dimensional presentations.

The data record in question, displayed for example as a tab, is normally in this case presented in the foreground, and preferably indicates the selected data record. A confirmation field, for example a card index tab, is indicated for each relation that is linked to the centre of the star. This tab can be clicked in order to be presented with a list/set of all of those objects in the selected data record which are related to the originally selected objects/data records(?).

If a reference object is a data record or a selection within a data record, a star-shaped data model of data records and relations is retrieved in the present invention, in which the focus preferably always remains on a reference object.

If there is no relation between the “data record A” and the “data record D” of a reference object, these can be combined in one complex data record. All the relations with this reference object are produced in a star-shaped model. If one relation is selected, this relation is placed in the foreground, and a further data record is produced, which may likewise be a complex data record, that is to say a combination of a data record related to A and a data record related in the same way with D.

If the reference object comprises a plurality of data records A and B which are related to one another, a complex data model is formed, which comprises an aggregation of the star-shaped models of A and B with common nodes.

In one possible application of the present invention, the data records comprise product data and/or characteristic variables which are relevant for marketing or for production, for example chemical or physical parameters of the production process, the raw materials, end products or intermediate products. By way of example, data records relating to melting temperatures of various plastics are stored in the database, and one data record relates to the temperature of a heat treatment in a production process as a characteristic variable. By way of example, the relation comprises the melt products which are compatible with that characteristic variable. Comparative and replacement product, as well as their storage and marketing conditions, can be indicated quickly and efficiently by tracing the relation. This speeds up production and marketing procedures.

In a further application of the present invention, the data records are used during the production of a product and, for example, comprise characteristic variables which are used directly to control the production process.

The invention also relates to an apparatus having a database, a data input appliance, and a data output appliance, which are designed such that, when at least one first data record is asked from the database, at least one relation which is associated with that data record is retrieved in order to form at least one further data record. By way of example, this relates to a database which is made available on a computer or on a server, and is managed and asked by means of a database management application. The data input appliance is, for example, a keyboard, a mouse or a scanner. The data output appliance is, for example, a screen or a printer. One particular embodiment of the apparatus according to the invention also has a data preprocessing unit, including a query module, a data record display module, which dynamically retrieves and displays a data record, and a relation display module, which dynamically retrieves and displays the relations of the data record that is retrieved with further data records, preferably in a star-shaped representation.

In one particular embodiment of the apparatus according to the invention, the data preprocessing appliance forms part of the access layer of a query system.

The production of the data records together with the associated relation or relations, for example by a joint display on a data output appliance, allows the linking of the data records with other further data records to be presented to the user and to be evaluated particularly quickly. The separate query of the database according to the prior art, for example on the basis of predetermined tree structures, in order to create the relation between the data records that have been found on the basis of the results that have been found, is comparatively time-consuming and complicated.

In one advantageous embodiment, the apparatus according to the invention is designed such that the further data record is additionally retrieved. In one refinement, the further data records are output in a star shape around the data record which was retrieved as the first data record, with the star-shaped linking reflecting the relation between the data records.

According to a further advantageous refinement of the method according to the invention, at least one further data record is retrieved after operation of a confirmation switch, which is provided for this purpose. For example, the retrieval of the further data record is initiated by operation of a key, by clicking of an index card tab with an input appliance, or by touching a touch-sensitive display in a confirmation field which is provided for this purpose. This allows the retrieval of information on the data output appliance to be speeded up, since the amount of data to be retrieved and to the output increases only “on request”, that is to say on confirmation. Furthermore, the clarity is improved by confirmation-controlled retrieval.

According to a further embodiment of the apparatus according to the invention, the retrieval of the previous data record is interrupted after operation of the confirmation switch. In consequence, the amount of data to be retrieved after calling further data records via the confirmation switch does not increase, since the presentation of the data record takes place sequentially. Furthermore, the clarity is improved by the sequential retrieval.

The invention also relates to a computer program for carrying out one of the embodiments of the method according to the invention as described above, when the computer program is run on a computer.

The invention also relates to a data storage medium on which the computer program for carrying out one of the embodiments of the method according to the invention as described above is stored.

### BRIEF DESCRIPTION OF THE DRAWINGS

FIG. 1: shows data records and direct relations from exemplary embodiment 1

FIG. 2: shows data records and direct as well as indirect relations from exemplary embodiment 1

FIG. 3: shows data records and direct relations from exemplary embodiment 2

FIG. 4: shows a typical structure for carrying out the method according to the invention. A Trip database and an Oracle database are addressed and managed centrally by an application server. The invention relates essentially to the so-called “graphical user interface” with which the query and production of the data records and relations are carried out using the application server tools.

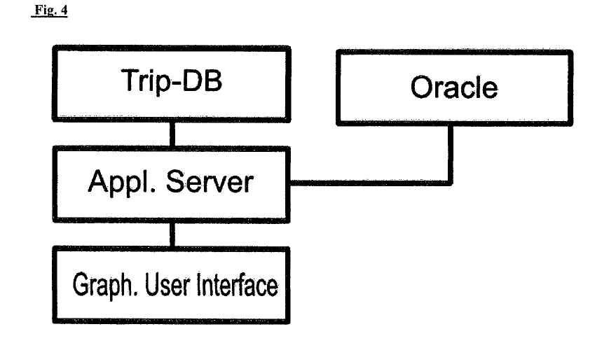

FIG. 5a and FIG. 5b: show illustrations of the data records and relations in the form of index cards.

FIG. 6: shows a spherical representation of the data records and relations.

### DESCRIPTIONS OF EXAMPLES OF DATA RECORDS AND RELATIONS WITH FURTHER DATA RECORDS

The invention will be explained in the following text using examples and with reference to the accompanying figures, without being restricted to them.

### EXAMPLE 1

### Presentation of the Data Records in the Form of Index Cards, with the Reference Object Being a Data Record or a Selection Within a Data Record

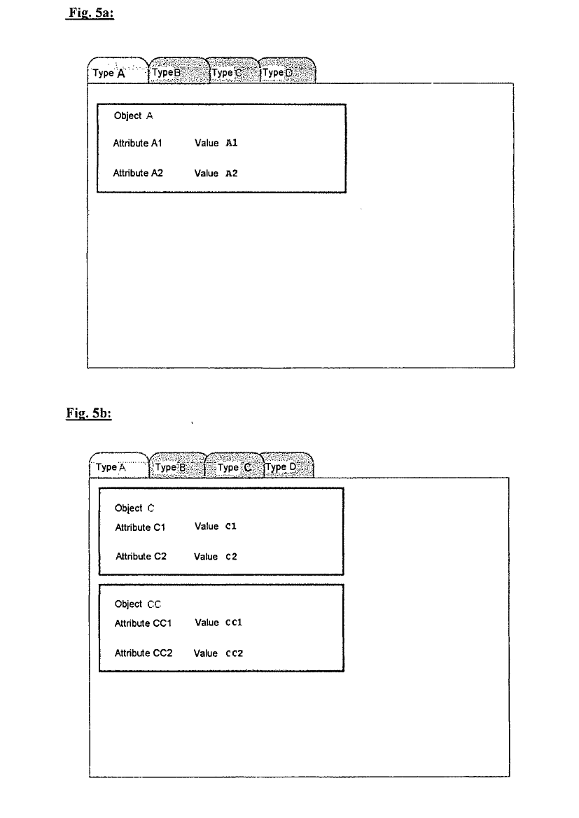

If a reference object is a data record or a selection within a data record (for example Type A), a star-shaped data model is produced, in the present invention, from the data records and relations, in which the focus always remains on a reference object, since only links originating from “Type A” lead to adjacent objects. For example, the data records linked by means of one or more relations are made available by visual presentation on index cards. In this case, an index card is always open and visible, and conceals underneath it cards of which only their index card tabs are visible. Data records or objects of a single type from the database are listed in the foreground on the card. The tabs on the concealed index cards show the data record or object types which can be accessed from the visible card (FIG. 5a). This arrangement models a detail from a database model, in which one data or object type is linked to others, or is related to them. Relations between data records and objects in the database can be navigated easily and quickly by the representation of the relation in index cards and index card tab form. The visible index card in the foreground forms the Type A reference object, and indicates its data records. The concealed index cards represent data records or object types which are arranged around the reference object in the database. If the tab of a concealed index card is used to select it, that is to say this is confirmed by operation of a confirmation key, it is moved to the foreground. All those data records and objects which are related to the objects on the initially active index card are listed on it. The inscription (and possibly also the quantity) on the concealed index cards changes in this step. The index tab, which represents the relation between the active index card and the reference object (FIG. 5b), is identified in particular. A new detail is shown from the data model.

### EXAMPLE 2

### Representation of the Data Records in the Form of Index Cards, with the Reference Object Being a Selection from a Plurality of Data Records

If there is no relation between the “data record A” and the “data record D”, these can be combined in one complex data record (represented as an index card). All the relations with this reference object are produced as index card tabs. When an index card tab is selected, it is moved to the foreground and a further data record is produced as an index card, which may likewise be a complex data record, that is to say a combination of a data record related to A and a data record with the same relationship with D.

If the reference object comprises a plurality of data records A and B which are related to one another, a complex data model is formed, which comprises an aggregation of a plurality of star-shaped models with common nodes. In other words “data record A” and “data record D” are each centrally surrounded by other data records; the relation between “A” and “D” links the two networks. If the complex data model is represented as index cards, the focus (identified tab) automatically now also changes, and updates the index cards and tabs when a change is made between two subnetworks (D-E-F and A-B-C).

### EXAMPLE 3

### Representation of the Data Records in the Form of a Sphere with Nodes

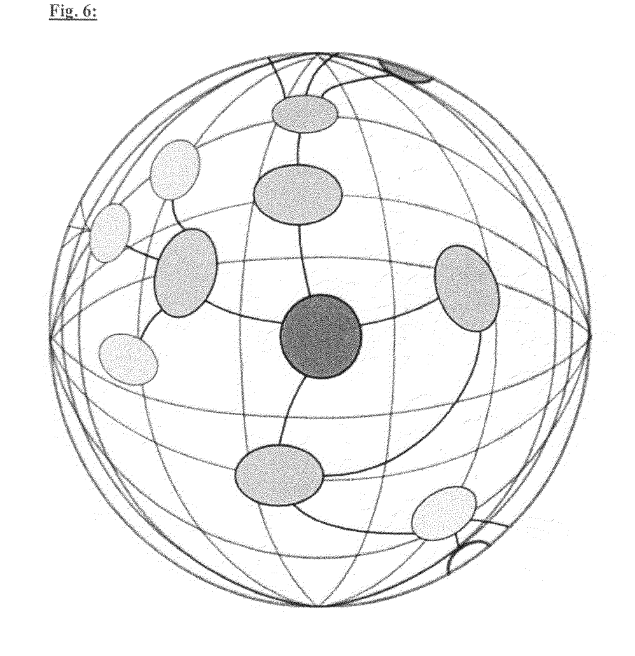

In this further example, the data records which are linked by one or more relations are produced by visual presentation on a sphere with nodes (FIG. 6). In this case, one node is always open and visible; this is shown coloured dark in FIG. 6, and centrally. Further nodes around this node indicate the data record or object types which can be accessed from the visible card (FIG. 5a). This arrangement models a detail from a database model in which one data or object type is linked to others, or is related to them. Relations between data records and objects in the database can be navigated easily and quickly by the representation of the relation between the visible nodes. The dark-coloured node in the foreground forms the Type A reference object, and can show its data records. The light nodes represent the data record or object types which are arranged around the reference object in the database. When another node is selected, that is to say it is confirmed by operation of a confirmation key, it is moved to the foreground. Activation of this node lists all of the data records and objects which are related to the objects of the initially active node. In this step, the inscription (and possibly also the quantity) of the light node changes. The node which represents the relation between the active node and the reference object (off-centre top, FIG. 6) is identified in particular. A new detail from the data model is shown.

### Exemplary Embodiments

### Exemplary embodiment 1: Car Licenses

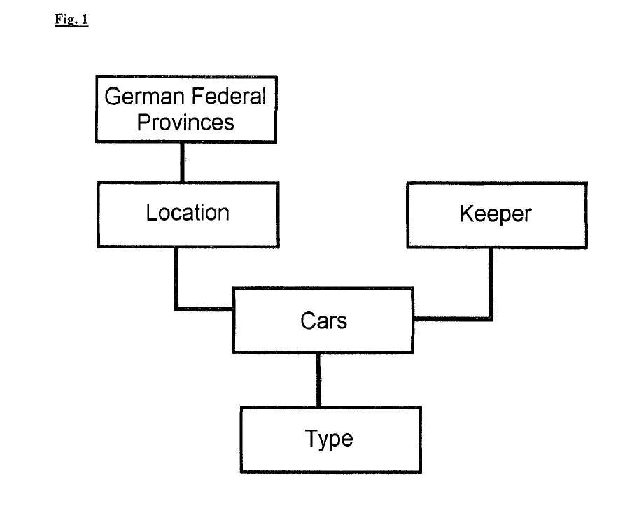

As sketched in FIG. 1, the database manages, for example, a plurality of information items relating to cars and the associated licensing information, and a check based on the object “car” with the attribute “green” generate a data record in the form of an object list, which lists the associated cars. A relation is retrieved, which corresponds to the link between the cars and the license location. After tracing this relation, a new data record is retrieved, for example a set or list of cars in a specific licensing location, or a set of or list of licensing locations which are linked to the previously listed cars. The further data record can be processed by attribute checking in one refinement by restricting the indicated location selection to all those locations which have more than 100 000 inhabitants. Furthermore, by way of example, a relation is indicated with the German Federal Provinces of the associated locations.

The set of green cars which are licensed in locations with more than 100 000 inhabitants is thus indicated by back-tracking of the previously mentioned relation between cars and the licensing location.

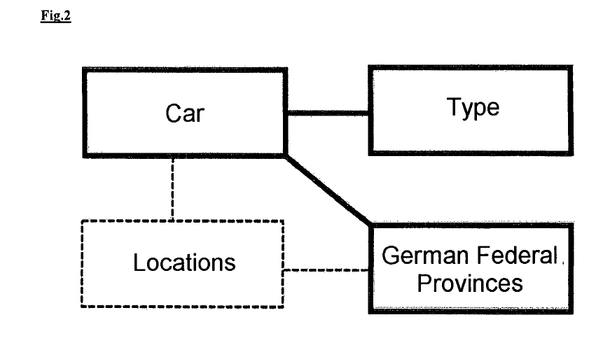

The index card tabs show and relate to all of the other data records which can be accessed with relations from the selected/central data record. These also include calculated or predetermined relations: there is a unique relationship from the vehicle to the licensing location, from the location to the German Federal Province. This makes it possible to jump directly from the car to the German Federal Province if, for example, the information about the licensing location is not required, as shown in FIG. 2. Index card tabs for the “vehicle” types are then “type” and “German Federal Province”.

### Exemplary Embodiment 2: Marketing Analysis

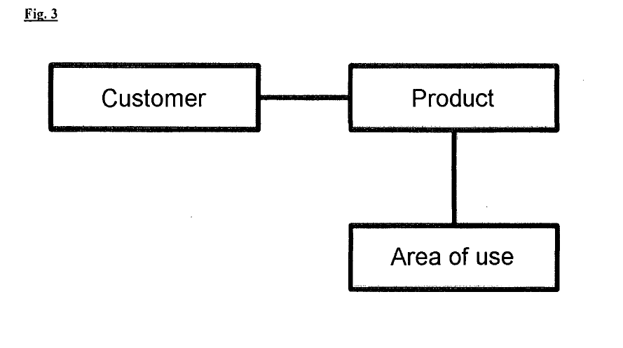

If the database is managing the products purchased by a number of customers from one manufacturer, then, for example, on production of the information relating to the products purchased by a customer, the link to a further area of use can be indicated. By retrieval of the information relating to this link, the user can evaluate this information and if required can follow it further, as shown in FIG. 3. If, by way of example, specific characteristics of products are managed in the database, the relation may be given, for example, by a characteristic which links the various products, such as identical or similar solubility ranges. This makes it possible to find comparative or replacement products, for example for production processes, particularly easily. For example, on the one hand the specific plastic product and its predetermined characteristic can be retrieved from the database for use as bumper bar for a motor vehicle. The latter characteristic may be used as a relation to further products in order in this way to find a replacement substance for the previously issued plastic.

A further investigation is to search for errors in relationships or relations, rather than for existing relations. When asking for specific products, a jump is made to the list of customers who have no references to these products. By way of example, this query results in all major customers (check of turnover greater than 100 000 Euros) who are not buying a specific product.

### Exemplary Embodiment 3: Research Result Analysis

In another example, the method is used for management of research results. For example, a query shows all the research reports by the author “X”. A relation with the specialist fields is offered, and indicates all other specialists fields in which that author has worked. If one element of the specialist field is selected, a list of the associated reports is output, by a relation with the associated reports.

Furthermore, the relation can make it easier to find substances and research results in order to carry out a product search and to offer available results to the customer.

In a further embodiment, patents and patent applications are managed together with their bibliographic data in the database. The relation is given, for example, by the classification of the patents or by the inventors.

### Further Exemplary Embodiments

Further exemplary embodiments comprise the following data records and the associated relations: documentation of pipeline links: linking of pipelines to pipeline segments, coordinates, works, pipe types and pipe materials, pipe contents, link to hazardous substance instructions, extinguishing regulations and safety regulations; control questions relevant to industrial engineering: indication of a customer, indication of the contracts with him, indication of the associated internal orders, indication of the employees who are working on the internal orders, indication of the associated costs and turnovers; project management: link of resources, milestones, requirement, tests and test records, project documentation; supply chain management, indication of deliveries, customers, suppliers, haulage companies, journeys, goods, etc.

1. A method for searching of at least one data source, with at least one first data record being searched and retrieved from the data source, and with at least one relation, which is associated with that data record, being retrieved in order to form at least one further data record.

2. A method for searching of at least one data source, data records and relations between data records, the method comprising the following steps:
a) inputting and searching of one or more reference objects,
b) retrieving one or more reference objects,
c) retrieving the relations between the reference objects with further data records,
d) outputting the reference objects and relations between the reference objects with further data records to the output appliance.

3. The method according to the claim 2, wherein the relations that are produced are navigable.

4. The method according to claim 3, further comprising the step of retrieving an additional data record with the production of the relation.

5. The method according to the claim 4, wherein, during the production of the further data record, the relations associated with it are in turn dynamically adapted.

6. The method according to claim 5, further comprising a confirmation step, wherein the further data record being retrieved after confirmation by the user in the confirmation step.

7. The method according to claim 2, wherein the retrieved data records are being selected, and wherein at least one relation which is associated with that selection being retrieved.

8. The method according to claim 2, wherein the data source being a relational database.

9. The method according to claim 2, wherein the data record and the relation being made available in a star-shaped representation.

10. An apparatus having a database, a data input appliance and a data output appliance, the apparatus comprising
a configuration that, when at least one first data record is searched from the database, at least one relation which is associated with that data record is retrieved in order to form at least one further data record.

11. The apparatus according to claim 10, wherein the apparatus is configured such that a further data record is additionally retrieved.

12. The apparatus according to claim 11, further comprising a confirmation switch, and wherein the additional data record being retrieved after operation of the confirmation switch.

13. The apparatus according to claim 10, wherein data records and relations are retrieved by a data preprocessing appliance.

14. The apparatus according to claim 10, wherein the data preprocessing appliance comprises a query module, a data record display module which dynamically retrieves and displays a data record, and a relation display module, which dynamically retrieves and displays the relations between the data record that is retrieved and further data records.

15. A computer program for carrying out claim 2, wherein the computer program is run on a computer.

16. A data storage medium for storing the method as claimed in claim 2.

17. A data storage medium for storing the computer program for carrying out the method as claimed in claim 2 is stored.
